(19) United States
(12) Patent Application Publication
(10) Pub. No.: US 2012/0067437 A1
(43) Pub. Date: Mar. 22, 2012

(54) TAP ARRANGEMENT

(75) Inventor: Lijun Xia, New South Wales (AU)

(73) Assignee: GLOBAL DRAGON INDUSTRIES CO. LTD.

(21) Appl. No.: 13/319,507

(22) PCT Filed: May 12, 2010
(86) PCT No.: PCT/CN2010/072647

§ 371 Date: Dec. 1, 2011

(30) Foreign Application Priority Data
May 12, 2009 (AU) 2009902087

(51) Int. Cl. F16K 51/00

(52) U.S. Cl. 137/317

(57) ABSTRACT

A tap arrangement (10) is provided, which includes a spout (15) for communicating and dispensing a primary fluid, and one or more spout fluid passages (20,25) located within the spout (15) for communicating and dispensing one or more secondary fluids, and a tap portion (30). The tap portion (30) includes a generally cylindrical tap body (35), a primary control (40), a secondary control (60) and a cap (65), and is adapted to allow a user to independently dispense the primary and the one or more secondary fluids.

### FIELD OF THE INVENTION

The present invention relates to taps and in particular to a tap arrangement adapted to allow a user to independently dispense a primary and one or more secondary fluids.

The invention has been developed primarily for use in kitchens and bathrooms and will be described hereinafter with reference to these applications. However, it will be appreciated that the invention is not limited to these particular fields of use. For example, the invention can also be used in a commercial or industrial setting.

### BACKGROUND OF THE INVENTION

In its simplest form, a tap is a valve that controls the release of a fluid (e.g. a liquid or gas). In most domestic and commercial settings, a tap controls the flow of water from a water source such as a mains water supply or a water tank to a bathtub or sink.

Water filters are often used in domestic and commercial settings to filter impurities from water. Point-of-use filters, such as granular activated carbon filters used to cleanse water for drinking are often installed at, under or adjacent to sinks, for example, kitchen sinks, to filter water as it is supplied from the mains. This allows a faucet or tap for dispensing the filtered water to be installed adjacent to the main tap(s). Some of these filter units include a built-in water cooler and/or heater for cooling or heating the filtered water before it is dispensed to use. For such devices, a faucet or tap having two separate controls, spouts and outlets leading from the cooler and heater individually dispense the cold and hot water, respectively. Jug filters are also commonly used, however these have the disadvantage of being able to only filter a small volume of water at a time.

In commercial settings, it is often desirable to have fluids other than water available at a point-of-use. For example, it may be desirable to have a mouth rinsing agent available in a dentist's room. These alternative fluids are usually dispensed at a separate tap or faucet at the point-of-use.

The present invention seeks to provide a tap arrangement which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, a tap arrangement adapted to allow a user to independently dispense a primary and one or more secondary fluids is provided, comprising:
a spout for communicating and dispensing the primary fluid,
one or more spout fluid passages located within and through the spout being adapted for communicating and dispensing the one or more secondary fluids, respectively, and
a tap portion adapted to be in fluid communication with the spout and the one or more spout fluid passages and to allow a user to independently control dispensing of the primary and the one or more secondary fluids.

Advantageously, more than one type of fluid can be compactly and conveniently dispensed at a single tap and spout. In one example, the primary fluid is water from a mains water supply, one of the secondary fluids is cold filtered water and another of the secondary fluids is hot filtered water.

Preferably, the tap portion comprises:
a tap body adapted to be secured to a surface, the spout being mounted to the tap body, and
a primary control mounted to the tap body, in fluid communication with the spout and being adapted to control the supply of the primary fluid through the spout.

Advantageously, the tap arrangement is adapted to be installed at a convenient location, such as a kitchen sink. Furthermore, the supply of primary fluid is independently controlled to the one or more secondary fluids.

Preferably, the tap body comprises:
one or more tap fluid passages corresponding to the one or more spout fluid passages, respectively, and
a secondary control for controlling the supply of the one or more secondary fluids from the one or more tap fluid passages into the one or more spout fluid passages.

Advantageously, when the or each of the one or more secondary fluids is to be dispensed for use, the secondary fluid is conveyed from a tap fluid passage into a corresponding spout fluid passage. Thus, control of the supply of the secondary fluid into the corresponding spout fluid passage controls the dispensing of the secondary fluid.

Preferably, the primary control is a mixer tap.

Advantageously, the mixer tap is an accurate and convenient method of controlling the supply and temperature of water from a mains water supply.

Preferably, the one or more spout fluid passages are two or more spout fluid passages, the one or more tap fluid passages are two or more tap fluid passages and the secondary control takes the form of a collar comprising a collar fluid passage adapted to provide fluid communication between one of the two or more tap fluid passages and a corresponding spout fluid passage when the collar is in a first position and to provide fluid communication between a second of the two or more tap fluid passages and a corresponding spout fluid passage when the collar is in a second position, the collar being adapted to stop fluid communication between the two or more tap fluid passages and the two or more spout fluid passages when the collar is in an off position.

Advantageously, the secondary control is achieved using a single mechanism configurable to different positions. The collar controls the supply of the two or more secondary fluids into the two or more spout fluid passages, and thus it directly controls the dispensing of the two or more secondary fluids.

Preferably, the one or more spout fluid passages are two or more spout fluid passages, the one or more tap fluid passages are two or more tap fluid passages and the secondary control takes the form of a collar comprising two or more collar fluid passages corresponding to the two or more spout fluid passages and the two or more tap fluid passages, a first of the two or more collar fluid passages being adapted to provide fluid communication between a first of the two or more tap fluid passages and a corresponding spout fluid passage when the collar is in a first position, a second of the two or more collar fluid passages being adapted to provide fluid communication between a second of the two or more tap fluid passages and a corresponding spout fluid passage when the collar is in a second position, the collar being adapted to stop fluid communication between the two or more tap fluid passages and the two or more spout fluid passages when the collar is in an off position.

Advantageously, different ones of the two or more secondary fluids are conveyed through completely independent tap fluid passages, spout fluid passages as well as collar fluid passages. This is advantageous if mixing of different secondary fluids is undesirable as it reduces or eliminates the possibility of cross-contamination between different secondary fluids.

Preferably, the collar is adapted to be manually rotatable for adjustment between at least the first, second and off positions.

Advantageously, the collar is easily adjusted to selectively dispense the two or more secondary fluids.

Preferably, the tap body further comprises an upper surface having an arcuate groove and the collar further comprises a lower surface having a pin depending therefrom, the pin being adapted to cooperate with the arcuate groove, such that in use, rotation of the collar is limited by the range of motion of the pin within the groove.

Advantageously, the mechanical limitation provided by the cooperation of the pin within the groove allows convenient and accurate user control of the dispensing of the two or more secondary fluids.

Preferably, the or each of the one or more spout fluid passages has an inlet located in a side wall of the spout.

Advantageously, this configuration allows fluid communication from the primary control to the spout to be conveyed substantially without obstruction from the one or more spout fluid passages.

Preferably, the spout comprises a spout outlet and the or each of the one or more spout fluid passages has an outlet located at the spout outlet.

Advantageously, the primary fluid and the one or more secondary fluids are discharged at the same outlet, for convenience and compactness.

Preferably, the one or more spout fluid passages generally follow an inner surface of the side wall of the spout.

Advantageously, the location of the one or more spout fluid passages adjacent to the side wall of the spout rather than towards a middle region of the spout reduces the impact of the frictional effects of the one or more spout fluid passages on the flow of the primary fluid through the spout. Furthermore, this allows the one or more spout fluid passages to be supported by the side wall of the spout for structural stability. This may be particularly important if the one or more spout fluid passages are narrow, as forces generated by fluid pressure may otherwise cause structural instability.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a perspective view of a tap arrangement adapted to allow a user to independently dispense a primary and one or more secondary fluids, comprising a spout for communicating and dispensing the primary fluid and one or more spout fluid passages for communicating and dispensing the one or more secondary fluids in accordance with a preferred embodiment of the present invention, the tap arrangement having a plurality of fluid lines connected thereto;

FIG. 2 is a schematic sectional side view of the tap arrangement of FIG. 1;

FIG. 3 is a sectional side view of a tap portion of the tap arrangement of FIG. 1, the tap portion comprising a tap body and a primary control, wherein the tap portion is adapted to be in fluid communication with the one or more spout fluid passages and one or more tap fluid passages and to allow a user to independently control dispensing of the primary and the one or more secondary fluids;

FIG. 4 is a schematic top view of the tap portion of FIG. 3;

FIG. 5 is a sectional side view of a cap of the tap portion of the tap arrangement of FIG. 1;

FIG. 6 is a sectional side view of a secondary control of the tap portion of the tap arrangement of FIG. 1, wherein the secondary control in the form of a collar is for controlling the supply of the one or more secondary fluids from the one or more tap fluid passages into the one or more spout fluid passages;

FIG. 7 is a bottom view of the collar of FIG. 6;

FIG. 8 is a schematic sectional side view of an upper portion of a spout of a tap arrangement in accordance with another preferred embodiment of the present invention;

FIG. 9 is a sectional side view of a lower portion of the spout of FIG. 8;

FIG. 10 is a bottom view of an attachment portion of the spout of FIG. 8;

FIG. 11 is a sectional side view of a tap portion of a tap arrangement in accordance with still another preferred embodiment of the present invention, the tap portion comprising a tap body and a primary control, wherein the tap portion is adapted to be in fluid communication with one or more spout fluid passages and one or more tap fluid passages and to allow a user to independently control dispensing of a primary and one or more secondary fluids;

FIG. 12 is a schematic top view of the tap portion of FIG. 11;

FIG. 13 is a sectional side view of a secondary control of the tap portion of FIG. 11, wherein the secondary control in the form of a collar is for controlling the supply of the one or more secondary fluids from the one or more tap fluid passages into the one or more spout fluid passages;

FIG. 14 is a bottom view of the collar of FIG. 13;

FIG. 15 is a sectional side view of a cap and the collar of FIG. 13, the cap and collar being adapted to be substantially aligned and disposed on a spigot portion of the tap body of FIG. 11, wherein the collar is in an open position;

FIG. 16 is a sectional side view of the cap of FIG. 15 and the collar of FIG. 13, the cap and collar being adapted to be substantially aligned and disposed on the spigot portion of FIG. 15, wherein the collar is in a closed position;

FIG. 17 is a schematic top view of a fixed disc (FIG. 17a) and a rotational disc (FIG. 17b), the fixed disc and rotational disc being adapted to be substantially aligned and interposed between a bottom surface of the collar and a top surface of the spigot portion of FIG. 15, in which the rotational disc is positioned relative to the fixed disc in the open position; and

FIG. 18 is a schematic top view of the fixed disc and rotational disc of FIG. 17, the fixed disc and rotational disc being substantially aligned and interposed between the bottom surface of the collar and the top surface of the spigot portion of FIG. 15, in which the rotational disc (FIG. 18b) is positioned relative to the fixed disc (FIG. 18a) in the closed position.

### DETAILED DESCRIPTION OF SPECIFIC EMBODIMENTS

It should be noted in the following description that like or the same reference numerals in different embodiments denote the same or similar features.

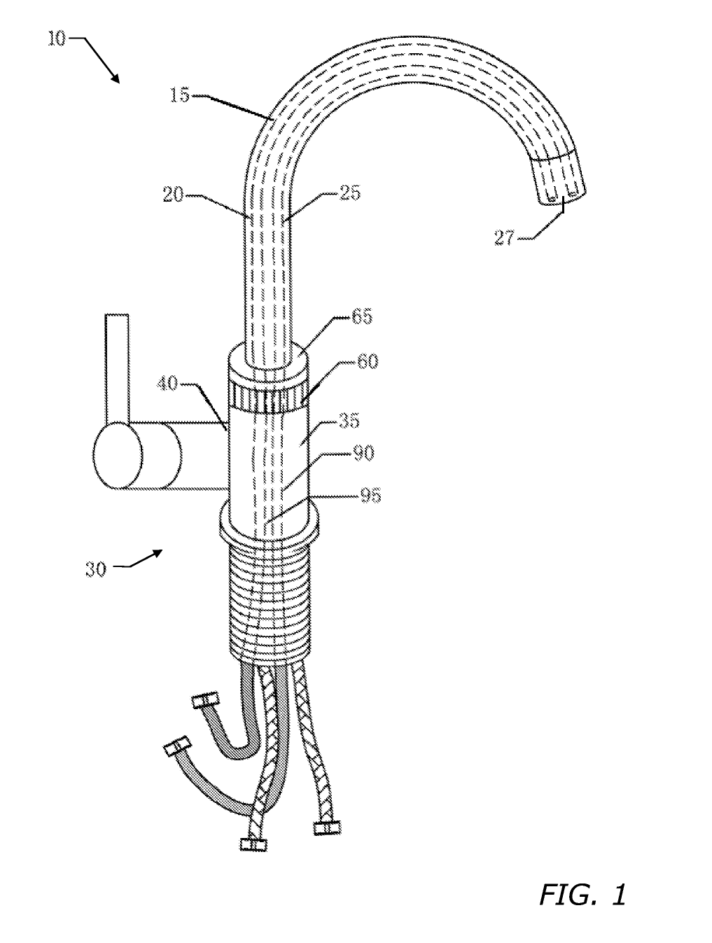

Referring to FIGS. 1 to 7, a tap arrangement 10 in accordance with a first preferred embodiment of the present invention is shown. The tap arrangement 10 is adapted to allow a user to independently dispense a primary and a first and a second secondary fluid.

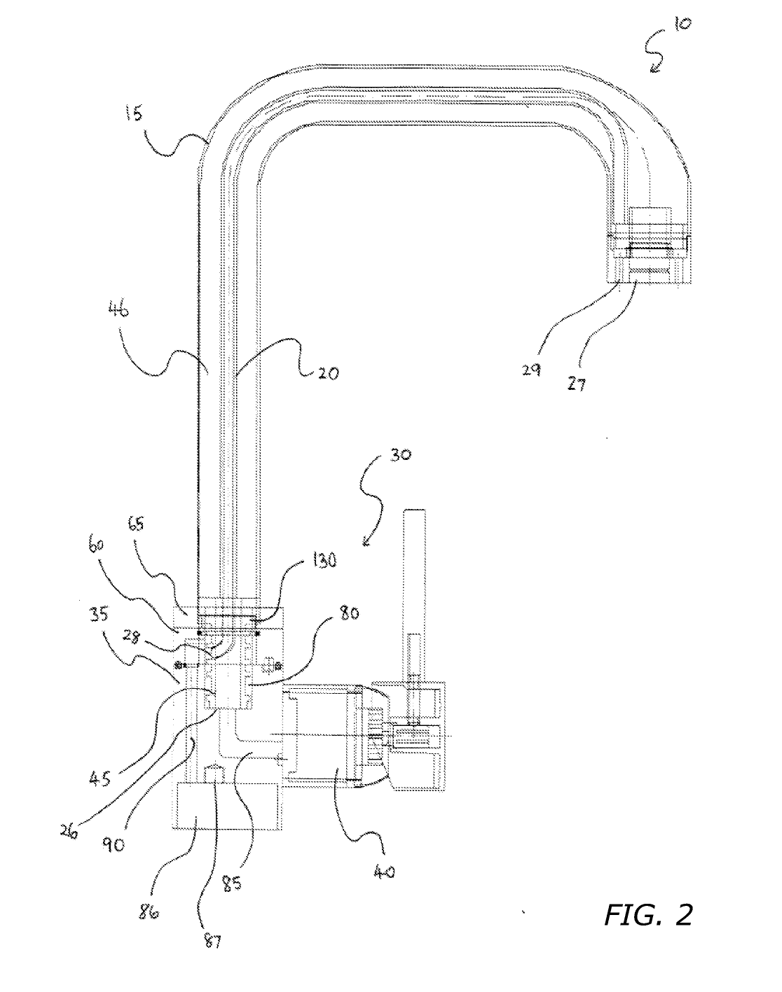

Referring specifically to FIGS. 1 and 2, the tap arrangement 10 comprises a spout 15 for communicating and dispensing the primary fluid, a first and a second spout fluid passage 20, 25 located within and through the spout 15 being adapted for communicating and dispensing the first and second secondary fluids, respectively and a tap portion 30 being adapted to allow a user to independently control dispensing of the primary and the first and second secondary fluids.

Referring specifically to FIG. 2, the spout 15 is generally hooked shaped, having a spout inlet 26 located at a lower end and a spout outlet 27 located at a hooked end adapted to direct the flow of fluid discharged from the spout in a generally downward direction. The spout outlet 27 comprises an aerator. The first and second spout fluid passages 20, 25 substantially comprise the same parts, and thus, for clarity, only the first spout fluid passage 20 is shown in FIG. 2 and will be described in detail. The first spout fluid passage 20 comprises a first spout fluid passage inlet 28 located at a lower portion and in a side wall of the spout 15. The first spout fluid passage 20 terminates at a first spout fluid passage outlet 29 located at the spout outlet 27. The first spout fluid passage 20 generally follows an inner surface of the side wall of the spout 15. Correspondingly, the second spout fluid passage 25 comprises a second spout fluid passage inlet and outlet (not shown). It should be noted that the second spout fluid passage inlet is located adjacent to the first spout fluid passage inlet 28 and aligned in substantially the same horizontal plane.

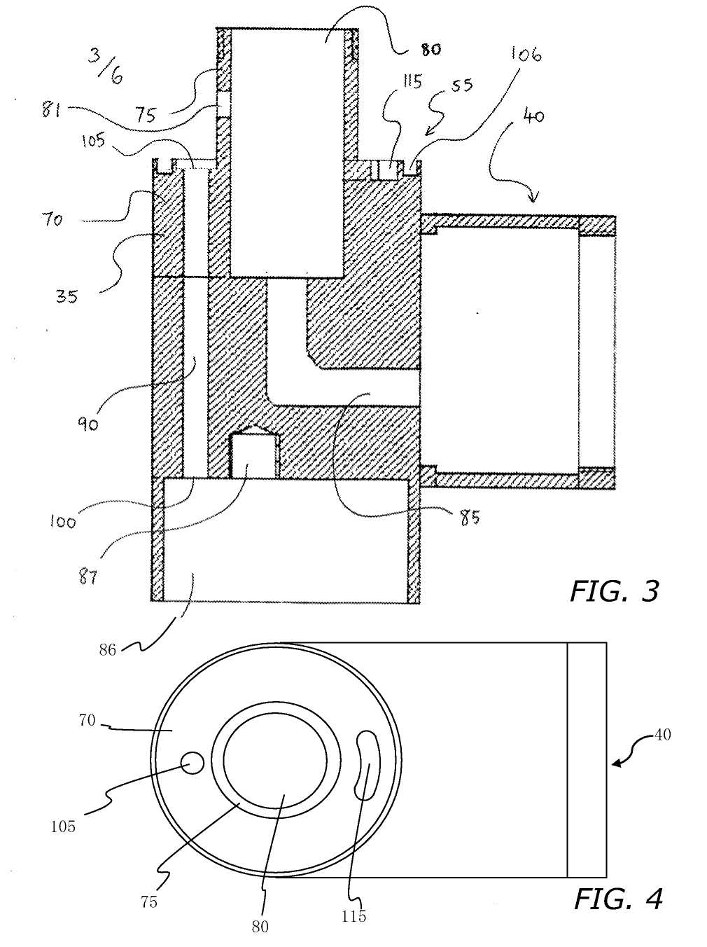

Referring also to FIGS. 3 and 4, the tap portion 30 comprises a generally cylindrical tap body 35 and a primary control 40. Both the spout 15 and the primary control 40 are mounted to the tap body 35. In this embodiment, the primary control 40 takes the form of a mixer tap adapted to control the supply of the primary fluid through the spout. The tap portion 30 further comprises between the spout 15 and the tap body 35 a secondary control 60 and a cap 65. The secondary control 60 and the cap 65 are mounted in sequence on an upper surface of the tap body 35.

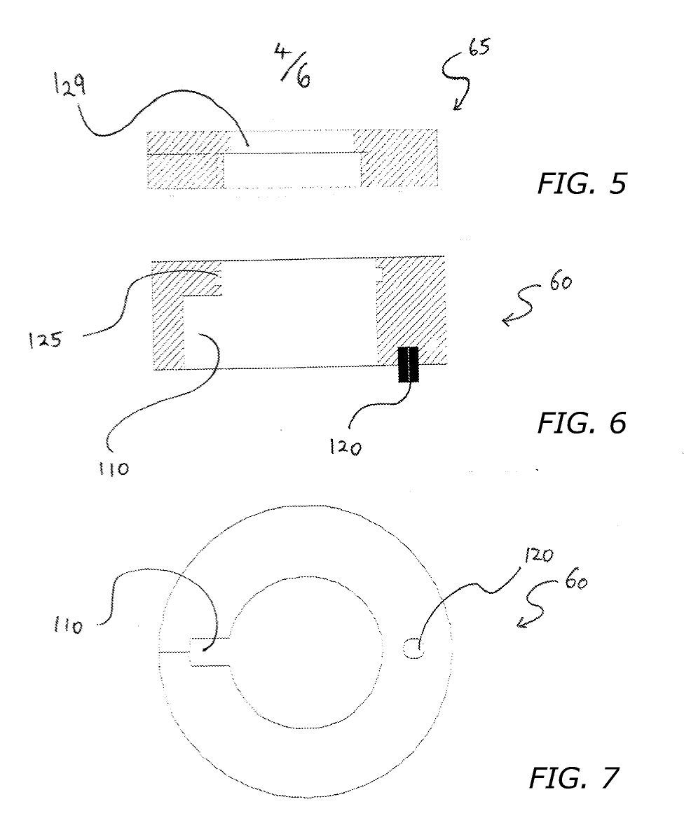

Referring also to FIGS. 5 to 7, the tap body 35 comprises a spigot portion 55. The spigot portion 55 comprises a lower portion 70, an integral upper portion 75 of smaller diameter and extending from the lower portion 70 (see FIG. 3) and a cylindrical cavity 80 located within the upper portion 75 and extending into the lower portion 70. The lower portion of the spout 15 forms a spout mounting 45 adapted for engagement with the cavity 80, such that the spout inlet 26 abuts an inner surface of the cavity 80. An outer surface of the spout mounting 45 comprises a plurality of circumferential lips. An upper portion of the spout 15 forms a rotatable portion 46 rotatably connected to the spout mounting 45. A side wall of the upper portion 75 of the spigot 55 also comprises a first aperture 81 (see FIG. 3) and second aperture (not shown) corresponding to the first spout fluid passage inlet 28 and the second spout fluid passage inlet (not shown), respectively. The mixer tap 40 is mounted to a side wall of the lower portion 70 of the spigot portion 55.

Referring to FIGS. 2 to 4, the spigot portion 55 further comprises a primary fluid passage 85 having an L-shaped elbow. A first end of the primary fluid passage 85 opens to the side wall of the spigot portion 55 and a second end of the primary fluid passage 85 opens to the cavity 80, such that, when the tap body 30 is assembled with the spout 15 and the mixer tap 40, the primary fluid passage 85 is adapted to communicate fluid between the mixer tap 40 and the spout 15.

The spigot portion 55 further comprises a cavity 86 located in a bottom surface and a fastener cavity 87 located within an inner surface the cavity 86 adapted to allow a fastener to be attached thereto. The tap body 35 is adapted to be secured to a surface by this fastener.

The spigot portion 55 also comprises a first and second tap fluid passage 90, 95 corresponding to the first and second spout fluid passages 20, 25, respectively. The first and second tap fluid passages 90, 95 substantially comprise the same parts, and thus, for clarity, only the first tap fluid passage 90 is shown in FIGS. 2 to 4. The first tap fluid passage 90 comprises a first tap fluid passage inlet 100 located at the inner surface of the cavity 86. The first tap fluid passage 90 extends substantially vertically and terminates at a first tap fluid passage outlet 105 located in a top surface of the lower portion 70 of the spigot 55. The first tap fluid passage outlet 105 comprises a groove adapted to house an o-ring. Correspondingly, the second tap fluid passage 95 comprises a second tap fluid passage inlet and outlet (not shown). It should be noted that the second tap fluid passage outlet is circularly aligned with the first tap fluid passage outlet 105. The top surface of the lower portion 70 of the spigot portion 55 comprises a circular groove (not shown) located toward an outer edge of the top surface adapted to house an o-ring fitted therein.

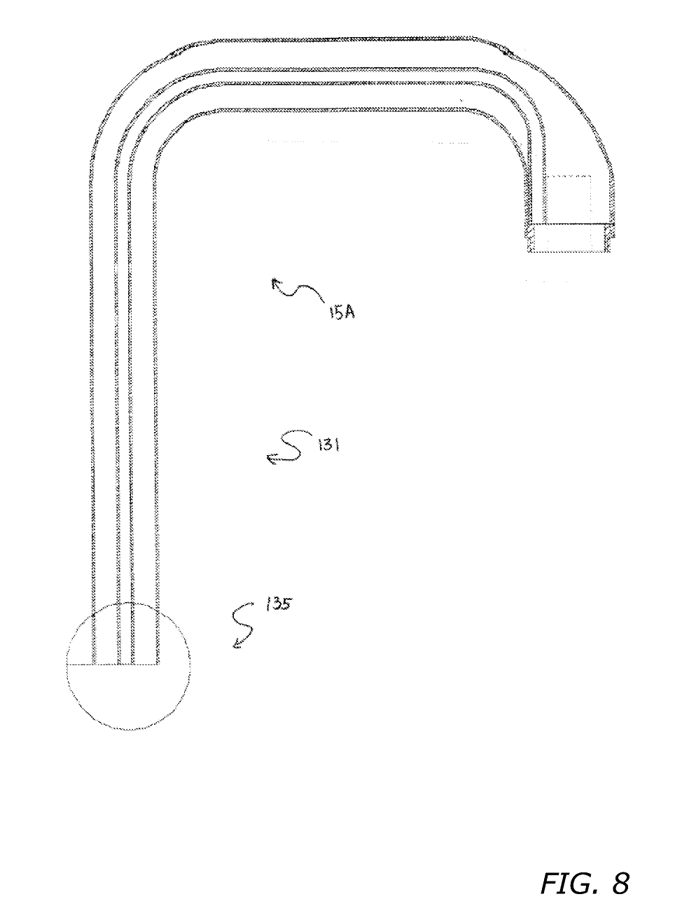

The secondary control 60 is adapted for controlling the supply of the first and second secondary fluids from the first and second tap fluid passages 90, 95 into the first and second spout fluid passages 20, 25, respectively. Referring specifically to FIGS. 6 and 7, the secondary control 60 takes the form of a collar having a hollow adapted to allow the upper portion 75 of the spigot portion 55 to be located therethrough. When assembled, a bottom surface of the collar 60 substantially abuts the top surface of the lower portion 70 of the spigot 55. An inner surface of the collar 60 comprises a recess 110 extending from the bottom surface to a generally middle region of the collar 60 forming a collar fluid passage.

The first tap fluid passage outlet 105 and the first spout fluid passage inlet 28 are substantially aligned such that when the collar 60 is in a first position, the collar fluid passage 110 connects the first tap fluid passage outlet 105 with the first spout fluid passage inlet 28 and thus provides fluid communication between the first tap fluid passage 90 and the first spout fluid passage 20. Similarly, the second tap fluid passage outlet (not shown) and the second spout fluid passage inlet are substantially aligned such that when the collar 60 is in a second position, the collar fluid passage 110 connects the second tap fluid passage outlet with the second spout fluid passage inlet and thus provides fluid communication between the second tap fluid passage 95 and the second spout fluid passage 25. Furthermore, when the collar 60 is in a third position such that the collar fluid passage 110 is not aligned with either the first or the second tap fluid passage outlets 105 and the first or the second spout fluid passage inlets 28, respectively, no fluid communication is provided between. In other words, it can be said that the collar 60 stops fluid communication between the first or the second tap fluid passages 90, 95 and the first or the second spout fluid passages 20, 25 respectively, when in an off position. The collar 60 is adapted to be manually rotatable for adjustment between at least the first, second and off positions.

The spigot portion 55 further comprises an arcuate groove 115 located in the top surface of the lower portion 70 (see FIGS. 3 and 4) and the collar 60 further comprises a pin 120 depending from a lower surface of the collar (see FIGS. 6 and 7). The pin 120 is adapted to cooperate with the arcuate groove 115 such that in use, rotation of the collar 60 is limited by the range of motion of the pin 120 within the arcuate groove 115. The collar further comprises an o-ring groove 125 located above the collar fluid passage 110 adapted to house an o-ring fitted therein (see FIG. 7). An outer surface of the collar 60 is ridged to allow the user to gain a better grip when rotating the collar 60 (see FIG. 1).

In another embodiment, the arcuate groove comprises a plurality of pairs of enlargements corresponding to the first, second and off positions of the collar 60, such that, as the collar is rotated, the pin is adapted to be securely stopped between adjacent pairs of enlargements until the collar is rotated onward with sufficient torque.

In yet another embodiment, the spigot portion 55 comprises the pin 120 located in the top surface of the lower portion 70 and the collar 60 comprises the arcuate groove 115 on its lower surface. It will be appreciated that in this embodiment, the pin 120 will be oriented in a substantially vertical direction from the top surface of the lower portion 70 to cooperate with the arcuate groove 115 such that in use, rotation of the collar 60 is limited by the range of motion of the pin 120 within the arcuate groove 115.

Referring specifically to FIG. 5, the cap 65 comprises a hollow 129 adapted to allow the upper portion 75 of the spigot portion 55 to be located therewithin and to cooperate with an upper portion 130 of the spout mounting 45. The hollow 129 has a larger upper diameter portion and a smaller lower diameter portion such that an undersurface of the upper portion 130 of the spout mounting 45 substantially abuts an upper surface of the lower diameter portion. When assembled, the spout 15 is secured to the tap body 35, and thus, the spout 15 and the cap 65 substantially stop the collar 60 from being vertically moved.

One of the major advantages of the tap arrangement 10 is that more than one type of fluid can be compactly and conveniently dispensed at a single tap and spout. In one example, the primary fluid is water from a mains water supply, the first secondary fluid is cold (or chilled) filtered water and the second secondary fluid is hot (or boiling) filtered water. The tap arrangement 10 is adapted to be installed at a convenient location, such as a kitchen sink, by virtue of being securable to a surface. Furthermore, the supply of the primary fluid is independently controlled in relation to the supply of the first and second secondary fluid, thus allowing, for example, the supply of the primary fluid to be permanently available and the supply of the first and second secondary fluids to be available only when required.

The mixer tap 40 is an accurate and convenient method of controlling the supply and temperature of water from a mains water supply. The collar 60 is effective as its utility is embodied in a single mechanism configurable to different positions to directly control the dispensing of the first and second secondary fluids. The collar 60 is also is easily adjusted to selectively dispense the first and second secondary fluids. Furthermore, the mechanical limitation provided by the cooperation of the pin 120 within the arcuate groove 115 allows convenient and accurate user control.

The positions of the first and second spout fluid passages 20, 25 and the first and second spout fluid passage inlets 28 and outlets 29 allow fluid communication from the mixer tap 40, through the primary fluid passage 85 to the spout 15 to be conveyed substantially without obstruction from the first and second spout fluid passages 20, 25. The positions of the first and second spout fluid passage outlets 29 allows the primary fluid and the first and second secondary fluids to be discharged at the same outlet, for convenience and compactness.

The location of the first and second spout fluid passages 20, 25 near to the inner surface of the side wall of the spout 15 rather than towards a middle region of the spout 15 reduces the impact of the frictional effects of the first and second spout fluid passages 20, 25 on the flow of the primary fluid through the spout 15. Furthermore, this allows the first and second spout fluid passages 20, 25 to be supported by the side wall of the spout for structural stability. This may be particularly important if the one or more spout fluid passages are narrow, as forces generated by fluid pressure may cause structural instability.

It should be noted that in other embodiments, three or more secondary fluids may be dispensed through correspondingly three or more spout and tap fluid passages.

In another embodiment (not shown), the collar comprises a first and second notch forming a first and second collar fluid passage. The first and second collar fluid passages correspond to the first and second tap fluid passages and the first and second spout fluid passages accordingly and respectively. When the collar is in a first position, the first collar fluid passage provides fluid communication between the first tap fluid passage and the first spout fluid passage. When the collar is in a second position, the second collar fluid passage provides fluid communication between the second tap fluid passage and the first spout fluid passage. The collar is also adapted to be selectively moved to an off position.

An advantage of this embodiment is that it allows the first and second secondary fluids to be conveyed through completely independent fluid passages, namely tap fluid passages, spout fluid passages as well as collar fluid passages. This is advantageous if mixing of different secondary fluids is undesirable as it reduces or eliminates the possibility of cross-contamination between different secondary fluids.

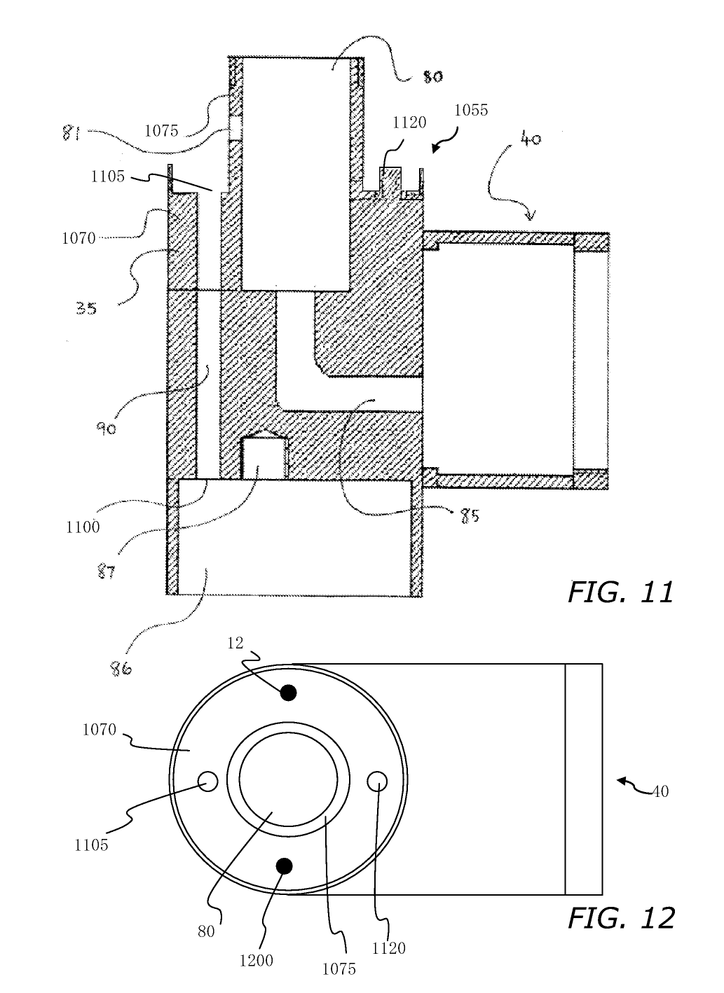

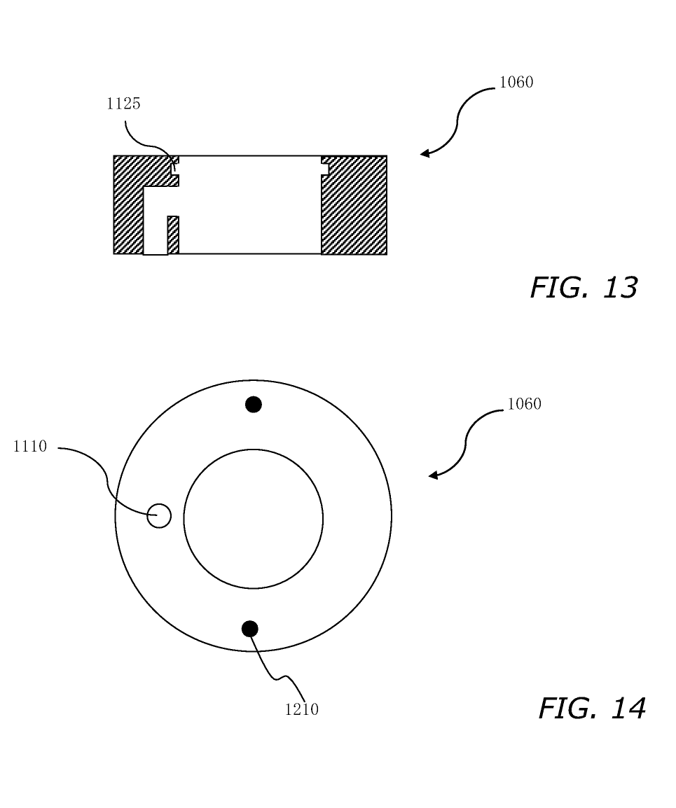

Referring specifically to FIGS. 11 to 18, in accordance with still another preferred embodiment of the present invention, the tap portion 30 of FIG. 1 comprises between the spout 15 and the tap body 35, the cap 65 of FIG. 5 and a secondary control 1060 in the form of a collar (see FIG. 13). The collar 1060 and the cap 65 are mounted in sequence on the upper surface of the tap body 35. The tap portion 30 further comprises a spigot 1055 having generally the same features as spigot 55 of FIG. 3 with the exception of a top surface of a lower portion 1070 of the spigot 1055 which comprises a pin 1120 (see FIGS. 11 and 12) and one or more spigot holding pins 1200, the pin 1120 and spigot holding pins 1200 all extending in a substantially upward direction relative to the top surface of the lower portion 70 of the spigot 1055.

A lower surface of the collar 1060 (see FIGS. 13 and 14) comprises a hollow adapted to allow an upper portion 1075 of the spigot 1055 to be located therethrough. An inner surface of the collar 1060 comprises a recess 1110 extending from the lower surface to a generally middle region of the collar 1060 forming a collar fluid passage. The lower surface of the collar 1060 further comprises one or more collar holding pins 1210 depending therefrom.

In this embodiment, and referring specifically to FIGS. 1, 11 and 12, the first tap fluid passage 90 (see FIG. 1) in the tap portion 30 extends substantially vertically and terminates at a first tap fluid passage outlet 1105 located in a top surface of the lower portion 1070 of the spigot 1055 (see FIGS. 11 and 12). The first tap fluid passage outlet 1105 and the first spout fluid passage inlet 28 in the spout 15 (see FIG. 1) are substantially aligned such that when the collar 1060 is in a first position, the collar fluid passage 1100 connects the first tap fluid passage outlet 1105 with the first spout fluid passage inlet 28 and thus provides fluid communication between the first tap fluid passage 90 and the first spout fluid passage 20. Similarly, the second tap fluid passage outlet (not shown) and the second spout fluid passage inlet (not shown) are substantially aligned such that when the collar 1060 is in a second position, the collar fluid passage 1110 connects the second tap fluid passage outlet with the second spout fluid passage inlet and thus provides fluid communication between the second tap fluid passage 95 and the second spout fluid passage 25. The first and second positions are open positions. Furthermore, when the collar 1060 is in a third position such that the collar fluid passage 1110 is not aligned with either the first or the second tap fluid passage outlets 1105 and the first or the second spout fluid passage inlets 28, respectively, no fluid communication is provided between. In other words, it can be said that the collar 1060 stops fluid communication between the first or the second tap fluid passages 90, 95 and the first or the second spout fluid passages 20, 25 respectively, when in a closed or off position.

The collar 1060 is adapted to be manually rotatable for adjustment between at least the first, second and off positions. In this embodiment, the collar further comprises an o-ring groove 1125 (see FIG. 13) located above the collar fluid passage 1110 adapted to house an o-ring fitted therein (not shown).

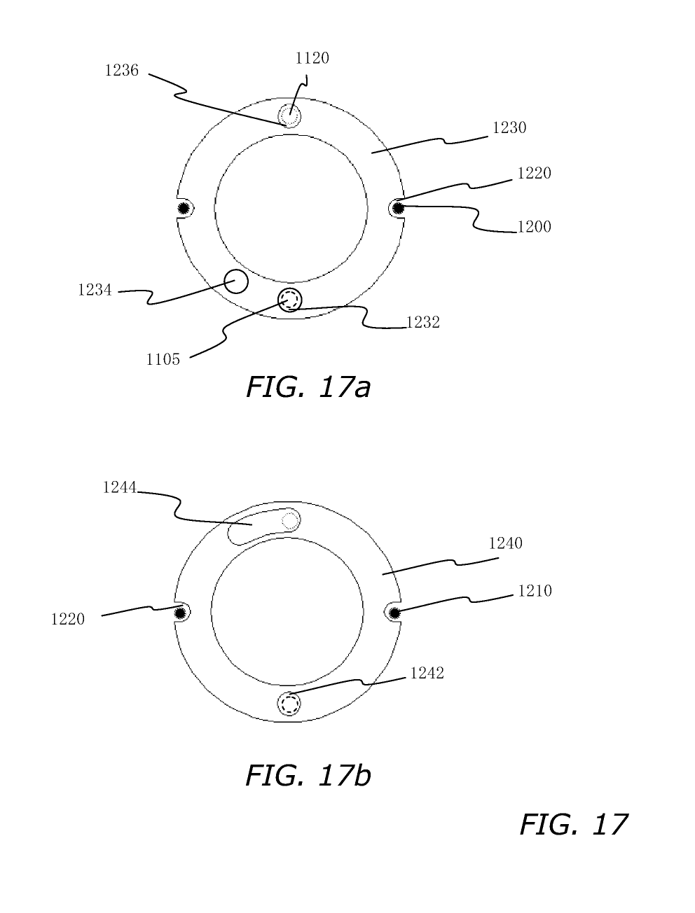

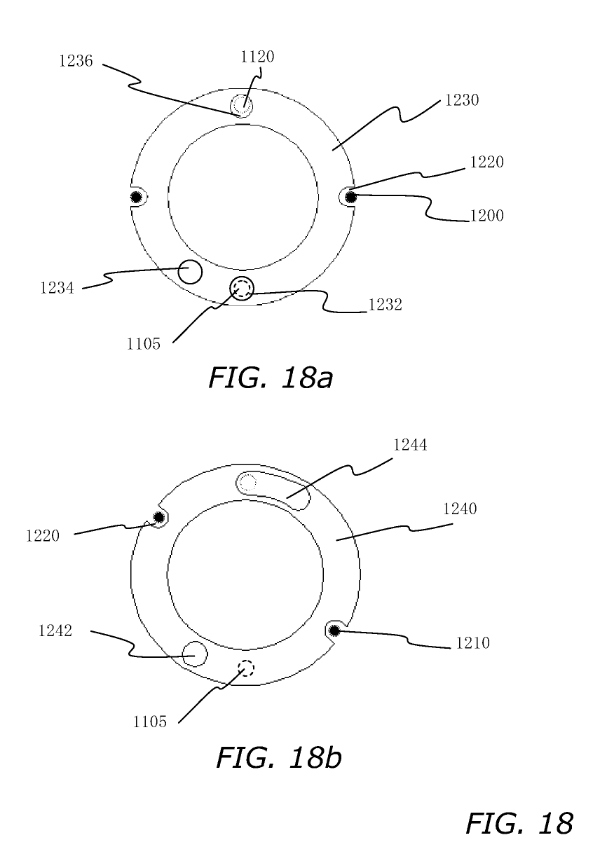

In this embodiment, the top surface of the lower portion 1070 of the spigot 1055 is adapted to receive one or more discs. The or each of the one or more discs comprises a hollow adapted to allow the upper portion 1075 of the spigot 1055 to be located therethrough. When assembled, the one or more discs are substantially aligned and interposed between the lower surface of the collar 1060 and the top surface of the lower portion 1070 of the spigot 1055. As shown in FIGS. 17 and 18, the one or more discs comprise one or more holding grooves 1220, one or more disc fluid passage apertures and an arcuate groove.

The one or more discs are manufactured from a suitable, hardwearing material to enable them to withstand the rigors of fluids passing through the tap arrangement 10 at high pressure. In this embodiment, the one or more discs are manufactured from a ceramic material such as silicon carbide, silicon nitride, alumina, zirconia oxide. It will be appreciated however, that one or more discs are not limited to being manufactured from a ceramic material and that any suitable material may be used, including, but not limited to, brass, stainless steel or bronze.

In this embodiment, the one or more discs are two discs, a first of the two discs being a fixed disc 1230 (see FIGS. 17a and 18a) adapted to substantially abut the top surface of the lower portion 1070 of the spigot 1055, and a second of the two discs being a rotational disc 1240 (see FIGS. 17b and 18b) adapted to substantially abut the lower surface of the collar 1060.

In this embodiment, the one or more disc fluid passage apertures in the fixed disc 1230 are two fixed disc fluid passage apertures, the first and second fixed disc fluid passage apertures 1232, 1234, respectively, and the one or more disc fluid passage apertures in the rotational disc 1240 is one rotational disc fluid passage aperture 1242.

The pin aperture in the fixed disc 1230 is a fixed disc pin aperture 1236 and the arcuate groove in the rotational disc 1240 is a rotational disc arcuate groove 1244. The fixed disc pin aperture 1236 and the rotational disc arcuate groove 1244 are both adapted to receive the pin 1120 of the top surface of the lower portion 1070 of the spigot 1055 therein.

It will be appreciated that the fixed disc pin aperture 1236 may be an arcuate groove as the fixed disc 1230 remains in a fixed position relative to the top surface of the lower portion 1070 of the spigot 1050 by way of the one or more spigot holding pins 1200 and is only required to cooperate with the pin 1120 in a fixed sense. The pin 1120 is adapted to cooperate with the rotational disc arcuate groove 1244 such that in use, rotation of the collar 1060 is limited by the range of motion of the pin 1120 within the rotational disc arcuate groove 1244.

The one or more holding grooves 1220 on the rotational disc 1240 are adapted to receive the one or more collar holding pins 1210 on the lower surface of the collar 1060 such that in use, rotation of the rotational disc 1240 relative to the collar 1060 is restricted by the collar holding pins 1210. The one or more holding grooves 1220 on the fixed disc 1230 are adapted to receive the one or more spigot holding pins 1200 on the top surface of the lower portion 1070 of the spigot 1055 such that in use rotation of the fixed disc 1230 relative to the spigot 1055 is restricted by the spigot holding pins 1200.

In this embodiment, the one or more spigot holding pins 1200 are two or more spigot holding pins 1200, and the one or more collar holding pins 1210 are two or more collar holding pins 1210.

When assembled, the fixed disc 1230 is mounted on the top surface of the lower portion 1070 of the spigot 1055 such that a first of the two fixed disc fluid passage apertures 1232 is substantially aligned with the first tap fluid passage outlet 1105 and a second of the two fixed disc fluid passage apertures 1234 is substantially aligned with the second tap fluid passage outlet (not shown), and the fixed disc pin aperture 1236 is adapted to cooperate with the pin 1120 oriented in a substantially vertical direction from the top surface of the lower portion 1070 of the spigot 1055. The rotational disc 1240 is mounted above and substantially abuts the fixed disc 1230, where the rotational disc 1240 is oriented such that the rotational disc fluid passage aperture 1242 is substantially aligned with the collar fluid passage 1105 in the collar 1060 and the rotational disc arcuate groove 1244 is adapted to cooperate with the pin 1120 such that in use, rotation of the collar 1060 causes rotation of the rotational disc 1240 relative to the fixed disc 1230, the rotation of the collar 1060 (and the rotational disc 1240) being limited by the range of motion of the pin 1120 within the rotational disc arcuate groove 1244.

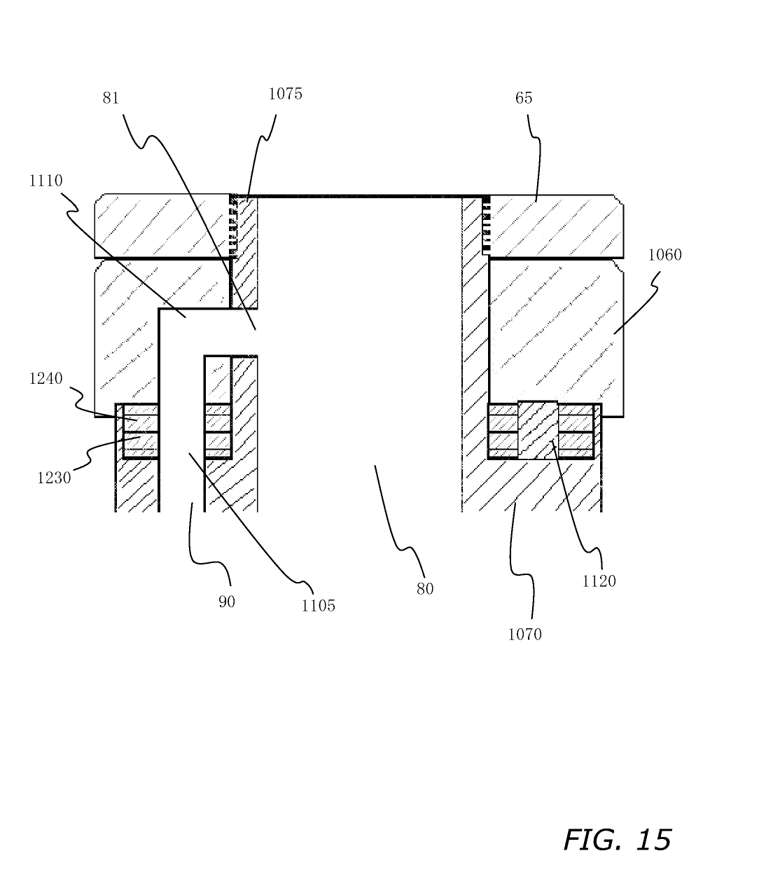

In use, when the collar 1060 is in the first position, as shown in FIG. 15, the rotational disc fluid passage aperture 1242, the first fixed disc fluid passage aperture 1232, the first tap fluid passage outlet 1105 and the first spout fluid passage inlet 28 in the spout 15 (see FIG. 1) are all substantially aligned, such that the collar fluid passage 1100 connects the first tap fluid passage outlet 1105 with the first spout fluid passage inlet 28 and thus provides fluid communication between the first tap fluid passage 90 and the first spout fluid passage 20.

Similarly, when the collar 1060 is in the second position, the rotational disc fluid passage aperture 1242, the second fixed disc fluid passage aperture 1234, the second tap fluid passage outlet (not shown) and the second spout fluid passage inlet (not shown) are all substantially aligned such that the collar fluid passage 1110 connects the second tap fluid passage outlet with the second spout fluid passage inlet and thus provides fluid communication between the second tap fluid passage 95 and the second spout fluid passage 25. The first position and the second position are open positions.

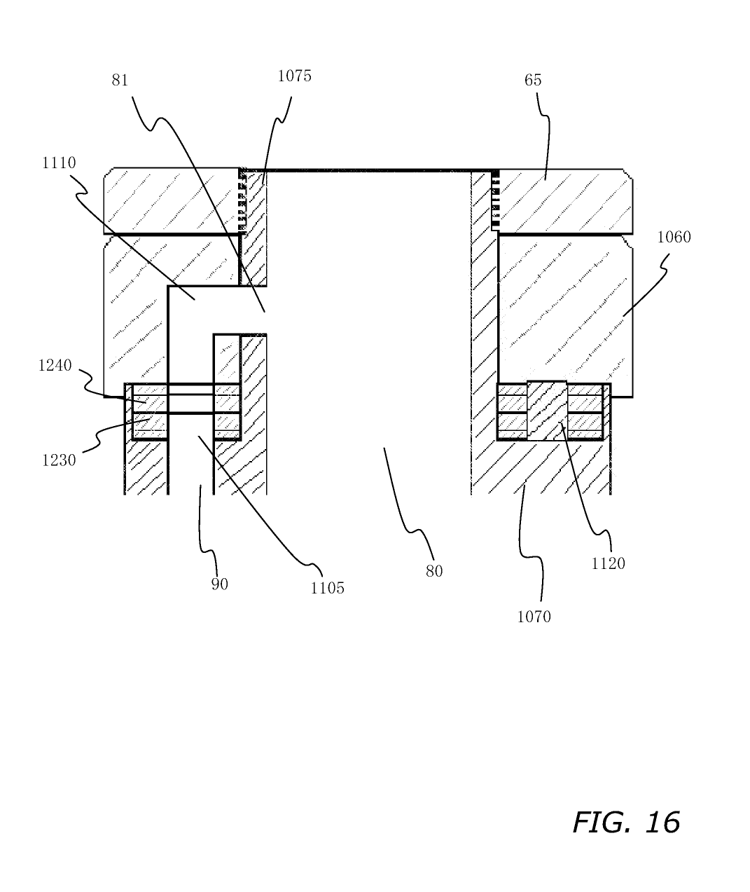

Furthermore, when the collar 1060 is in the closed or off position, as shown in FIG. 16, the rotational disc fluid passage aperture 1242 is not aligned with either the first fixed disc fluid passage aperture 1232 or the second fixed fluid passage aperture 1234, such that no fluid communication is provided between. In other words, it can be said that the collar 1060 stops fluid communication between the first or the second tap fluid passages 90, 95 and the first or the second spout fluid passages 20, 25 respectively, when in the off position.

As a result, rotation of the collar 1060 causes adjustment between at least the first, second and off positions.

It will be appreciated that one or more washers may be located in the tap portion 30 of the tap arrangement 10 to assist in sealing the tap portion 30 between the collar 1060 and the spigot 1055 from possible fluid leakage in use. In this embodiment, the top surface of the lower portion 1070 of the spigot 1055 is adapted to receive one or more washers (not shown). The or each of the one or more washers comprises a hollow adapted to allow the upper portion 1075 of the spigot 1055 to be located therethrough, and further comprise one or more holding grooves (not shown), one or more disc fluid passage apertures (not shown) and an arcuate groove (not shown).

The one or more washers are manufactured from a suitable, hardwearing material to enable them to withstand the rigors of fluids passing through the tap arrangement 10 at high pressure. In this embodiment, the one or more washers are manufactured from a suitable elastomeric material such as silicone, neoprene, nitrile butadiene rubber (NBR), ethylene propylene diene monomer (EPDM). It will be appreciated however, that the one or more washers are not limited to being manufactured from an elastomeric material and that any suitable material may be used.

In this embodiment, the one or more washers are two washers; a fixed washer (not shown) adapted to be substantially aligned with and interposed between the top surface of the lower portion 1070 of the spigot 1055 and a bottom surface of the fixed disc 1230, and a rotational washer (not shown) adapted to be substantially aligned with and interposed between the lower surface of the collar 1060 and a top surface of the rotational disc 1240 when assembled. The fixed washer and the rotational washer not only assist in providing a good fluid seal as described above, but they also provide a protective layer to protect the fixed disc 1230 and rotational disc 1240 from direct contact with the top surface of the lower portion 1070 of the spigot 1055 and the bottom surface of the collar 1060, respectively.

In this embodiment, the collar 1060 is manually adjustable to the first position by rotating the collar 1060 in an anti-clockwise direction from the off position relative to the fixed disc 1230 and manually adjustable to the second position by rotating the collar 1060 in a clockwise direction from the off position relative to the fixed disc 1230. It will be appreciated that in other embodiments, the first position and second position may be achieved by rotating the collar 1060 in a clockwise and anti-clockwise direction, respectively, from the off position relative to the fixed disc 1230.

In this embodiment, an outer surface of the collar 1060 is ridged to allow the user to gain a better grip when rotating the collar 1060.

In another embodiment, the rotational disc arcuate groove 1244 may comprise a plurality of pairs of enlargements corresponding to the first, second and off positions of the collar 1060, such that, as the collar 1060 is rotated, the pin 1120 is adapted to be securely stopped between adjacent pairs of enlargements until the collar 1060 is rotated onward with sufficient torque.

In another embodiment, the tap arrangement 10 may comprise a biasing arrangement for automatically biasing the collar 1060 to the off position. The biasing arrangement may be any suitable biasing arrangement, for example, one or more torsional springs (not shown), for interconnecting the collar 1060 and, for example, the upper portion 1075 of the spigot 1055. It will be appreciated that the collar 1060 may be automatically biased to any of the first, second, and off positions.

In other embodiments, it will be appreciated that the one or more disc fluid apertures in the fixed disc 1230 may depend on the number of secondary fluids being fluidly communicated and dispensed from the spout 15.

It should be noted that in other embodiments, three or more secondary fluids may be dispensed through correspondingly three or more spout, tap and collar fluid passages. To accommodate the additional spout, tap and collar fluid passages within the tap arrangement 10, it will be appreciated by persons skilled in the art that parts of the tap arrangement 10 may need to be redesigned accordingly.

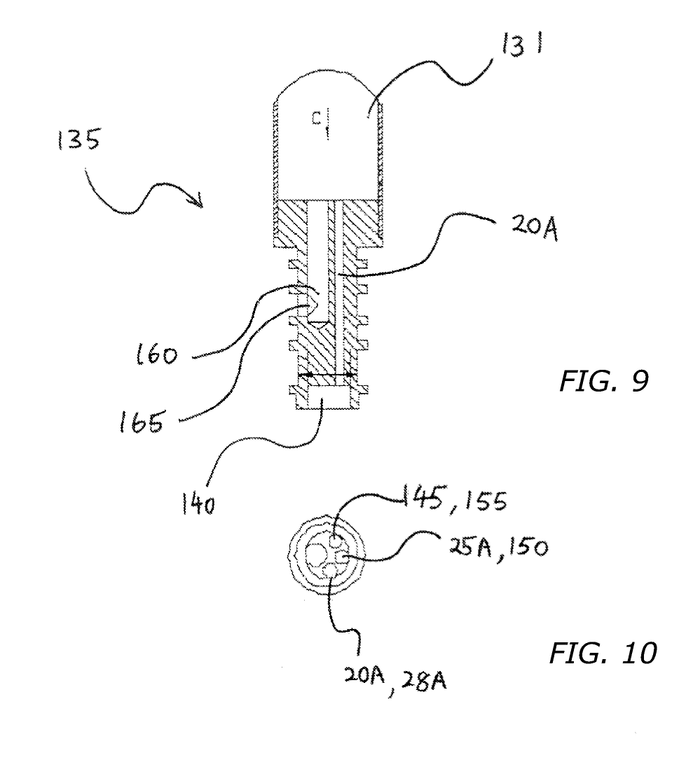

Referring to FIGS. 8 to 10, a spout 15A of a tap arrangement in accordance with a second preferred embodiment of the present invention is shown. In this embodiment, while a majority portion 131 of the spout 15A is hollow, a lower portion 135 of the spout 15A is not hollow. The lower portion 135 comprises a cavity 140 located in a bottom surface of the lower portion 135 (see FIG. 9). The spout 15A comprises a first, second and third spout fluid passage 20A, 25A, 145 (see FIG. 10) having a first, second and third spout fluid passage inlet 28A, 150, 155, respectively, located in an inner surface of the cavity 140. Only the first spout fluid passage 20A is shown in FIG. 9. The spout 15A additionally comprises a spout primary fluid passage 160 adapted to convey fluid through the lower portion 135 to the hollow majority portion 131 of the spout 15A. The spout primary fluid passage 160 comprises a spout primary fluid passage inlet 165 located in a side wall of the lower portion 135.

In other embodiments, it will be appreciated that the collar 60 (or 1060) may further comprise, for example, a lever arm (not shown) to enable those users with limited physical ability, an easier means to manually rotate the collar.

In an alternative embodiment, the tap arrangement 10 may comprise a rotational actuator (not shown) for automatically rotating the collar 60 (or 1060). The rotational actuator may be located, for example, within the tap body 35, and preferably controlled by an electronic controller (not shown); the electronic controller and rotational actuator being adapted to draw power from a low voltage power supply (not shown), such as, for example, a 5V, 10V, or 12V power supply. To accommodate the rotational actuator within the tap arrangement 10, it will be appreciated by persons skilled in the art that parts of the tap arrangement 10 may need to be redesigned accordingly.

In another embodiment, it will be appreciated that when, for example, the second secondary fluid is hot (or boiling) filtered water, heated by a heater (not shown), any steam that is generated, from the boiling filtered water, is likely to cause pressure to build up in the second tap fluid passage 95 of the tap arrangement 10. This will be particularly relevant in the situation where the collar 60 (or 1060) is in the off position and the second secondary fluid is prevented from being dispensed from the second spout fluid passage outlet (not shown). In this respect, it will be appreciated that between the heater and the second tap fluid passage 95 will be located, for example, a non-return valve (not shown) to enable the pressure to be released. Preferably, the steam will be released via a steam release passage (not shown) extending from the second spout fluid inlet to the aerator at the spout outlet 27, and released therefrom.

It will be appreciated that the steam release passage is insulated from its surroundings using a suitable insulating material, including but not limited to, any one or more of the following insulating materials: fibre glass, foam, mineral wool, paper covering, vinyl film covering and metal foil covering. In this respect, the heat loss through the steam release passage may be reduced, whilst also preventing the steam release passage from being inadvertently cooled by, for example, the first and second secondary fluid passages 20, 25. It will also be appreciated that the steam release passage may be substantially coiled to increase the surface area of the coil to maximise the ability to cool the steam or at least reduce the temperature of the steam prior to it being released from the aerator at the spout outlet 27.

In this embodiment, it will be appreciated that the spout 15 and the first and second secondary fluid passages 20, 25 are insulated from their surroundings using a suitable insulating material, including but not limited to, any one or more of the following insulating materials: fibre glass, foam, mineral wool, paper covering, vinyl film covering and metal foil covering. In this respect, the first and second secondary fluid passages 20, 25 may be prevented from being inadvertently heated by, for example, the steam release passage. Further, for example, when the first secondary fluid is cold (or chilled) filtered water and the second secondary fluid is hot (or boiling) filtered water, the first and second secondary fluid passages may be insulated from each other using the suitable insulating material so as to prevent the inadvertent transfer of heat from the second secondary fluid passage 25 to the first secondary fluid passage 20.

In yet another embodiment, the tap arrangement 10 preferably comprises a heater switch (not shown) controllable by an electronic controller (not shown) and powered by a low voltage supply (not shown) to enable a user to switch the heater on or off. In one example, the heater switch is a simple on/off switch that the user can operate manually. In this example, the heater switch is a push button switch, or a “light switch”. In another example, the heater switch is a toggle switch. The heater switch may be located anywhere on or around the tap arrangement 10. In this embodiment, the heater switch is located on the tap portion 30 for convenient access by the user.

In this embodiment, the tap arrangement 10 further comprises a heater switch sensor (not shown) controllable by the electronic controller and adapted to alert the user that the heater switch, and thereby the heater, is switched on. The heater switch sensor is preferably a light indicator powered by a low voltage supply (not shown) and controlled by the electronic controller. For example, the heater switch sensor may be, for example, a light emitting diode (LED) indicator, adapted to illuminate to indicate that the heater switch (and heater) are switched on. It will be appreciated that the heater switch sensor will not be illuminated when the heater is switched off.

In this embodiment, the electronic controller comprises a processor (not shown) adapted to receive and process the heater switch data. Once the heater switch data is processed, the electronic controller sends an appropriate instruction to the heater to heat the water.

In this embodiment, the first secondary fluid may be, for example, cold (or chilled) filtered water cooled by a cooler (not shown). In one example, the cooler is operated constantly such that the first secondary fluid passage is able to supply cold (or chilled) filtered water automatically without the need for a user to operate a switch to switch the cooler on or off.

In another embodiment, when the first secondary fluid is, for example, cold (or chilled) filtered water cooled by a cooler (not shown); the cooler may be adapted to be switched on or off by way of a cooler switch (not shown). The cooler switch may be controllable by the electronic controller and powered by a low voltage supply. In one example, the cooler switch is located near the heater switch and is a simple on/off switch that the user can operate manually. In this example, the cooler switch is a push button switch, or a “light switch”. In another example, the cooler switch is a toggle switch. The cooler switch may be located anywhere on or around the tap arrangement 10, such as, for example, the cooler switch may be located on the tap portion 30 for convenient access by the user.

In this embodiment, the tap arrangement 10 further comprises a cooler switch sensor (not shown) controllable by the electronic controller and adapted to alert the user that the cooler switch, and thereby the cooler, is switched on. The cooler switch sensor is preferably a light indicator powered by a low voltage supply and controlled by the electronic controller. For example, a cooler switch sensor may be, for example, a LED indicator, adapted to illuminate to indicate that the cooler switch (and cooler) is switched on. It will be appreciated that the cooler switch sensor will not be illuminated when the cooler is switched off.

In yet another embodiment, a single secondary fluid switch (not shown) is adapted to enable the user to switch between switching the cooler on and the heater off, switching the heater on and the cooler off, and switching both the heater and the cooler off. The single secondary fluid switch may be located anywhere on or around the tap arrangement 10, such as, for example, the single secondary fluid switch may be located on the tap portion 30 for convenient access by the user.

In another embodiment, the tap arrangement 10 comprises a spout 15 for communicating and dispensing the primary fluid, and only a single secondary spout fluid passage (not shown). In this embodiment, the single secondary fluid passage is adapted to dispense a first secondary fluid, a second secondary fluid, and a mixture of the first secondary fluid and the second secondary fluid. In one example, the first secondary fluid is cold (or chilled) filtered water and the second secondary fluid is hot (or boiling) filtered water. In this example, therefore, the first secondary fluid and the second secondary fluid can be mixed together to provide a mixed secondary fluid that has a temperature intermediate that of the first secondary fluid and the second secondary fluid. It will be appreciated that in this embodiment, the tap arrangement may comprise a temperature sensor (not shown) adapted to sense the temperature of the primary fluid and the one or more secondary fluids leaving the spout outlet 27 and to send the corresponding temperature sensor data to the electronic controller for processing. For example, the primary fluid having a desired temperature may be generated by monitoring the temperature sensor data of the primary fluid as it is dispensed from the spout outlet 27. The temperature sensor data may be displayed on a display panel of a remote control (not shown), or on a display panel (not shown) located in proximity to the tap arrangement 10, such that in use, a user can monitor the temperature of, for example, the primary fluid and adjust the relative supply of hot primary fluid and cold primary fluid at the mixer tap 40 until the primary fluid having the desired temperature is obtained. In another example, when the second secondary fluid is hot (or boiling) filtered water, the temperature sensor may be adapted to sense when the second secondary fluid has reached boiling temperature and to accordingly display the temperature sensor data on a display panel.

In this embodiment, the tap arrangement 10 may be adapted for fluid communication with one or more reservoirs (not shown), the one or more reservoirs being adapted for storing the one or more secondary fluids and being in fluid communication with the one or more tap fluid passages 90, 95, to realise a liquid dispensing system (not shown). It will be appreciated that the liquid dispensing system may be installed in either a domestic or a commercial setting.

In this embodiment, the liquid dispensing system comprises a cooler (not shown) and/or heater (not shown) for cooling or heating the one or more secondary fluids supplied from the one or more reservoirs before being dispensed for use. The liquid dispensing system further comprises a pump (not shown) for controlling the flow of the one or more secondary fluids supplied from the one or more reservoirs to the tap arrangement 10. The liquid dispensing system also comprises one or more fluid purification devices (not shown) such as, for example, a charcoal filter, a chlorine or fluorine filter, an ultraviolet source, a deionising filter, an ultrafiltration membrane filter and/or a reverse osmosis system, for purifying the one or more secondary fluids.

In this embodiment, the tap arrangement 10 may comprise one or more switches for activating, for example, the cooler or heater for cooling or heating the one or more fluids supplied from the one or more reservoirs before being dispensed. The one or more switches are preferably a single secondary fluid switch (not shown) adapted to enable the user to switch between switching the cooler on and the heater off, switching the heater on and the cooler off, switching the heater on and the cooler on, and switching both the heater and the cooler off. In another example, the single secondary switch may be adapted to enable the user to switch the heater on or off, there being no option to switch the cooler on or off as the cooler may be configured to operate automatically. In this embodiment, the single secondary fluid switch may be, for example, a push button switch. In this example, successive pushes of the single secondary switch will enable the user to switch to a desired option. Alternatively, the single secondary fluid switch may be a toggle switch. The single secondary fluid switch may be located anywhere on or around the tap arrangement 10, such as, for example, the single secondary fluid switch may be located on the tap portion 30 for convenient access by the user.

In this embodiment, the tap arrangement 10 may further comprise a single secondary fluid switch sensor (not shown) controllable by the electronic controller and adapted to alert the user that the single secondary fluid switch, and accordingly the heater and/or cooler, is switched on. The single secondary fluid switch sensor preferably comprises one or more light indicators powered by a low voltage supply (not shown) and adapted to illuminate by the electronic controller when the tap arrangement 10 is controlled by a user to dispense the one or more fluids. In one example, the one or more light indicators are two or more LED indicators, one or more of the two or more LED indicators adapted to illuminate when the single secondary fluid switch is switched by a user to, for example, turn the cooler on to provide cool (or chilled) filter water, turn the heater on to provide hot (or boiling) filtered water, or turn both the heater and cooler on to provide a mixture of hot and cold water in the form of, for example, warm water. It will be appreciated that the one or more light indicators will not be illuminated when the single secondary fluid switch is switched to switch either the cooler or heater off.

In this embodiment, the electronic controller comprises a processor (not shown) adapted to receive and process the single secondary fluid switch data. Once the single secondary fluid switch data is processed, the electronic controller sends an appropriate instruction to the heater and/or cooler to heat and/or cool the water.

In another embodiment, particularly in, but not limited to, regions where the chlorine content of water affects its colour, taste and/or odour, the liquid dispensing system may comprise a chlorine filter adapted to reduce the chlorine content of the one or more secondary fluids supplied from the one or more reservoirs, such that the colour, taste and/or odour of the one or more secondary fluids has been improved upon supply of the one or more secondary fluids through the single secondary fluid passage. The chlorine filter may be adapted to filter the one or more secondary fluids comprise, for example, one or more filters of activated carbon filters. In this embodiment, the single secondary fluid switch may be adapted to enable the user to switch between switching one or more of the cooler, heater and chlorine filter, on or off. The single secondary may take the form of, for example, a push button switch or a toggle switch, and may be located anywhere on or around the tap arrangement 10.

In this embodiment, the one or more light indicators are controllable by the electronic controller and adapted to alert the user that the single secondary fluid switch, and accordingly the heater, cooler and/or chlorine filter, is switched on. In one example, the one or more light indicators are three or more LED indicators, one or more of the three or more LED indicators adapted to illuminate when the single secondary fluid switch is switched by a user to, for example, turn on one or more of the cooler, heater and chlorine filter. In this example, a first operation of the single secondary fluid switch switches on the cooler and illuminates the first LED indicator; a second operation of the single secondary fluid switch switches on the heater, switches off the cooler, illuminates the second LED indicator and ceases illumination of the first LED indicator; a third operation of the single secondary fluid switch switches on the chlorine filter, switches off the heater, illuminates the third LED indicator and ceases illumination of the second LED indicator; and a fourth operation of the single secondary fluid switch switches off the chlorine filter and ceases illumination of the third LED indicator.

In still another embodiment, the liquid dispensing system may be adapted to supply fluid which bypasses, for example, the heater and cooler, such that fluid may be supplied through the one or more secondary fluid passages to the tap arrangement 10 and dispensed from the spout outlet 27 without having been heated or cooled by the heater or cooler, respectively. The temperature of this secondary fluid is in accordance with the ambient temperature of the liquid dispensing system. Accordingly, the single secondary fluid switch may be further adapted to operate the tap arrangement 10 such that, in one of its operations, the heater and cooler are switched off and the one or more secondary fluids are supplied through the one or more secondary fluid passages. Further, the one or more light indicators are four or more light indicators, the fourth LED indicator being adapted to illuminate when the single secondary fluid switch is operated to dispense the secondary fluid at ambient temperature.

### Interpretation

### Processes:

Unless specifically stated otherwise, as apparent from the following discussions, it is appreciated that throughout the specification discussions utilizing terms such as “processing”, “computing”, “calculating”, “determining”, “analyzing” or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Embodiments:

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

While the invention has been described with reference to a number of preferred embodiments it should be appreciated that the invention can be embodied in many other forms.

It should be noted that the tap arrangements 10, 10A as well as other embodiments described in the specification comprise standard tap accessories such as o-rings and aerators that are incorporated for their standard purposes but have not been described in detail.

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

### INDUSTRIAL APPLICABILITY

It is apparent from the above, that the arrangements described are applicable to domestic and commercial settings.

1. A tap arrangement adapted to allow a user to independently dispense a primary and one or more secondary fluids, comprising:
a spout for communicating and dispensing the primary fluid,
one or more spout fluid passages located within and through the spout being adapted for communicating and dispensing the one or more secondary fluids, respectively, and
a tap portion adapted to be in fluid communication with the spout and the one or more spout fluid passages and to allow a user to independently control dispensing of the primary and the one or more secondary fluids.

2. A tap arrangement as claimed in of claim 1, wherein the tap portion comprises:
a tap body adapted to be secured to a surface, the spout being mounted to the tap body, and
a primary control mounted to the tap body, in fluid communication with the spout and being adapted to control the supply of the primary fluid through the spout.

3. A tap arrangement as claimed in of claim 2, wherein the tap body comprises:
one or more tap fluid passages corresponding to the one or more spout fluid passages, respectively, and
a secondary control for controlling the supply of the one or more secondary fluids from the one or more tap fluid passages into the one or more spout fluid passages.

4. A tap arrangement of claim 2, wherein the primary control is a mixer tap.

5. A tap arrangement of claim 3, wherein the one or more spout fluid passages are two or more spout fluid passages, the one or more tap fluid passages are two or more tap fluid passages and the secondary control takes the form of a collar comprising a collar fluid passage adapted to provide fluid communication between one of the two or more tap fluid passages and a corresponding spout fluid passage when the collar is in a first position and to provide fluid communication between a second of the two or more tap fluid passages and a corresponding spout fluid passage when the collar is in a second position, the collar being adapted to stop fluid communication between the two or more tap fluid passages and the two or more spout fluid passages when the collar is in an off position.

6. A tap arrangement of claim 3, wherein the one or more spout fluid passages are two or more spout fluid passages, the one or more tap fluid passages are two or more tap fluid passages and the secondary control takes the form of a collar comprising two or more collar fluid passages corresponding to the two or more spout fluid passages and the two or more tap fluid passages, a first of the two or more collar fluid passages being adapted to provide fluid communication between a first of the two or more tap fluid passages and a corresponding spout fluid passage when the collar is in a first position, a second of the two or more collar fluid passages being adapted to provide fluid communication between a second of the two or more tap fluid passages and a corresponding spout fluid passage when the collar is in a second position, the collar being adapted to stop fluid communication between the two or more tap fluid passages and the two or more spout fluid passages when the collar is in an off position.

7. A tap arrangement of claim 5, wherein the collar is adapted to be manually rotatable for adjustment between at least the first, second and off positions.

8. A tap arrangement of claim 7, wherein the tap body further comprises an upper surface having an arcuate groove and the collar further comprises a lower surface having a pin depending therefrom, the pin being adapted to cooperate with the arcuate groove, such that in use, rotation of the collar is limited by the range of motion of the pin within the groove.

9. A tap arrangement of claim 1, wherein each of the one or more spout fluid passages has an inlet located in a side wall of the spout.

10. A tap arrangement of claim 1, wherein the spout comprises a spout outlet and the or each of the one or more spout fluid passages has an outlet located at the spout outlet.

11. A tap arrangement of claim 1, wherein the one or more spout fluid passages generally follow an inner surface of the side wall of the spout.

12. (canceled)

13. A tap arrangement of claim 3, wherein the primary control is a mixer tap.

14. A tap arrangement of claim 6, wherein the collar is adapted to be manually rotatable for adjustment between at least the first, second and off positions.
